(19) United States
(12) Patent Application Publication
(10) Pub. No.: US 2008/0108772 A1
(43) Pub. Date: May 8, 2008

(54) NANOCOMPOSITES BASED ON CELLULOSE WHISKERS AND CELLULOSE PLASTICS

(75) Inventors: Kristiina Oksman, Trondheim (NO); Daniel Bondeson, Trondheim (NO); Peder Syre, Oslo (NO)

Correspondence Address: ROTHWELL, FIGG, ERNST & MANBECK, P.C., 1425 K STREET, N.W., SUITE 800, WASHINGTON, DC, 20005, US

(73) Assignee: NTNU Technology Transfer AS, Trondheim (NO)

(21) Appl. No.: 11/560,190

(22) Filed: Nov. 15, 2006

(30) Foreign Application Priority Data
Nov. 8, 2006 (NO) 20065147

(51) Int. Cl. C08F 251/02

(52) U.S. Cl. 527/314

(57) ABSTRACT

The present invention discloses a method for producing a reinforced organic polymeric material by mixing a dispersion comprising a plasticizer and cellulose nanowhiskers into a carbon matrix. The nanowhiskers are dispersed in a liquid dispersion and pumped into an extruder in which is arranged the at least partially molten carbon matrix. The extrusion process will thoroughly mix the cellulose whiskers into the carbon matrix, thus providing a homogenous mixture being highly reinforced. The present invention further discloses a polymer produced according to the above process comprising a CAB/CNW mixture, as well as a process for producing said whiskers.

A considerable demand exists for renewable and biodegradable plastics to be used for various purposes. Previous attempts to provide such plastics have met with mixed results, either not being sufficiently strong, or not being sufficiently bio-degradable. The present invention discloses a strong nanocomposite comprised mainly of cellulose compounds, and thus provides an environmentally beneficial solution satisfying both the above criteria.

### GENERAL BACKGROUND

Cellulose is the most abundant of naturally occurring organic compounds. As the main constituent of the cell walls of higher plants it comprises at least one third of the vegetable matter of the world. In spite of its wide distribution in nature, cellulose for chemical purposes is derived commercially from two sources, cotton linters and wood pulp. Evidently the exploitation of cellulose within the field of polymer manufacture would be beneficial if the produced polymer exhibited the desired properties.

Cellulose esters for instance are useful polymers when manufacturing plastics. The most important of the esters is cellulose acetate. Cellulose acetates are more costly than other commercial polymers like PVC, PS and polyolefins, but retain their small market share due to their advantageous characteristics. Since the early 1990s biodegradable cellulose acetates have been available. These systems are centred around the use of an additive which acts both as a plasticizer and biodegrading agent, causing the cellulose acetate to decompose within 6-24 months.

It is known that polymer properties can be modified and improved by reinforcement with fibres. For instance glass-, carbon-, aramid, natural fibres may be used to increase the mechanical properties of the pure polymer as is well known. In order to form a fully bio-degradable system use of natural fibres is a possible approach. The use of natural fibres to reinforce the polymer must per force involve compromises between preferred properties as the increase of one material property often comes at the expense of another. Typical trade-offs may be between stiffness and toughness or toughness and transparency.

The use of nanoscale reinforcements allows the avoidance of such trade-offs as the reinforcements are so small that they do not easily scatter light, thus allowing the addition of such reinforcing materials without reducing the transparency of the resulting plastic. The interfacial area of the reinforcing particles is very large due to the small size of the particles, and the reinforcing particle will thus to a great extent interact with the polymer further enhancing the effectiveness of the reinforcement.

The reduced particle size of the additive further eliminates the shortcomings of using larger scale particles, as for the lower scale particles there are little or no break initiators in the local vicinity of the reinforcing materials.

In comparison to conventional materials, which contain a multiplicity of grain boundaries, voids, dislocations and imperfections, single crystal whiskers approach structural perfection and have almost eliminated such defects. The resultant is a highly ordered structure showing exceptional properties. The mechanical strength of the whiskers may approach the binding forces of adjacent atoms.

If additionally the reinforcing material is comprised of a biodegradable material, and this reinforcement is mixed into a biodegradable matrix, it is possible to obtain a completely biodegradable plastic material having a combination of desirable properties.

It has however proven difficult to manufacture the amount of nanoscale reinforcements necessary for the large-scale production of such biodegradable plastics. The problems of upscaling the production process to achieve large amounts of reinforced plastics have additionally never been adequately solved. The production of such nanoscale reinforcements has been very costly and it has proven difficult to achieve an adequate dispersion of the reinforcing material in the matrix to be reinforced.

The above problems have resulted in the use of such plastics being of small industrial interest, however the present invention discloses means and materials for overcoming said problems.

### BACKGROUND ART

Multiple attempts have been made to manufacture biodegradable polymers being strong, thermally stable, cheap, and being adapted for large scale production.

Grunert and Winter^{[1]} describe a material comprising Cellulose Acetate Butyrate reinforced by cellulose nanocrystals, however the authors were not able to adequately disperse the cellulose nanocrystal reinforcement without performing a trimethylsilation of the nanocrystals. The individual crystals show a tendency to aggregate thus weakening the polymer, and no significant strengthening of the material was reported. Additionally the cellulose nanocrystals were extracted by means of sulphuric acid hydrolysis, thus probably weakening the crystals. Lastly the nanocrystals were obtained from bacterial cellulose, a very time consuming and costly process, suitable mainly for very small scale production. The characteristics of the resulting polymer were not substantially improved.

Oksman et al.^{[2]} describe a method for producing a reinforced polymer comprising a polylactic acid matrix material and a microcrystalline cellulose reinforcing material. The materials were mixed in an extruder using a melt compounding technique. The microcrystalline cellulose reinforcing material is swelled/separated by a N,N-Dimethyl acetamide (DMAc) and lithium chloride (LiCl) mixture. However the strength and the thermal stability of the resulting polymer are significantly lower than for the present invention. Furthermore LiCl can cause degradation of cellulose, and is thus undesirable for use with cellulose. The dispersion of the microcrystalline reinforcements was furthermore reported to be incomplete, thus the reinforcements provided insufficient reinforcement to the matrix material.

Peterson and Oksman^{[3]} describe the use of either a swelled bentonite or a swelled microcrystalline material for the reinforcement of a polylactic acid matrix. However, the resulting polymer is weaker and less thermally stable than the polymer of the present invention. Furthermore the optical clarity of the reinforced polymer is inferior to the optical clarity of the disclosed polymer.

In a review of organic nanocomposites Peijs and Vilaseca^{[4]} present several different cellulose based nanocomposites, such as nanocomposites based on bacterial compounds, chitin and paper. The authors point out the inherent difficulties of adequately dispersing the cellulose whiskers, and the polymeric materials to be reinforced have very low strengths, a tensile true stress of about 15 MPa for a reinforcement percentage of about 25 wt %, and very low glass temperatures.

In a second review of the state of the art at the time, Gacitua, Ballerini and Zhang^{[5]} discussed various approaches to using cellulose nanocomposites as reinforcing materials in polymers. Reference is made to the above cited work of Grunert and Winter^{[1]}. However the authors stress the inherent difficulties of both dispersing the nanocrystals in the polymer matrix and the difficulty of obtaining more than very small amounts of the nanocrystals. As has been discussed, the work of Grunert and Winter^{[1]} did not provide any significant reinforcement of the polymer matrix.

Nair and Dufresne in a series of papers^{[6,7,8]} describe the use of crab shell chitin whiskers as reinforcements for a natural rubber. The chitin whiskers were isolated by means of an acid hydrolysis before being swelled and mixed with the natural rubber. The resulting composite was in most instances vulcanized. However the resulting polymer exhibits quite low glass temperatures, and inferior mechanical properties when compared to the polymer of the present invention. The chemical properties and preparation of chitin whiskers also differ from the whiskers prepared according to the current invention.

Kim et al.^{[9]} describe the difficulties of melt compounding nano-sized particles into individual functioning organic polymers, and conclude by stating that mixing blending agglomerated nanoparticles into polymers by conventional plastic melt/compounding methods does not work. This prejudice of the background art is overcome in the present invention.

Bondeson, Mathew and Oksman^{[10]} describe a method for producing large quantities of nanocrystals from microcrystalline cellulose by acid hydrolysis, however sulphuric acid (H₂SO₄) is used for the acid hydrolysis. The use of sulphuric acid as the hydrolysing agent weakens the nanocrystals, and thus the resulting reinforced polymer. Additionally the resulting polymer has been shown to be more opaque when using nanocrystals produced by means of sulphuric acid.

Morin and Dufresne[11] describe an acid hydrolysis method for the isolation of Chitin whiskers, in which hydrochloric acid is used as the hydrolysing agent. However, the chemical properties of Chitin differ substantially from the chemical properties of cellulose and no polymer is proposed.

The present invention discloses a method for producing a polymer, said method being cheap and upscalable, and in which the resulting biodegradable polymer exhibits superior properties to the polymers as disclosed in the prior art. The uniform dispersion of the reinforcing nanowhiskers is a crucial improvement over the prior art resulting from the improved production method by mixing the nanoreinforcements into the polymer matrix by compound melting, a method previously thought to be impractical if not impossible.

### SHORT SUMMARY OF THE INVENTION

The present invention discloses a method for producing a reinforced organic polymeric material comprising the following steps:
providing a carbon based matrix material,
providing a dispersion comprising at least a plurality of cellulose nano whiskers and a liquid plasticizing material, said plasticizing material for plasticizing said carbon based matrix material. The novel and inventive steps of the invention are characterised in
furnishing said carbon based matrix material and said dispersion to an extruder so as for forming a mixture of said dispersion with said carbon based matrix material,
homogenizing said mixture by passing said mixture through at least a portion of said extruder said cellulose nano whiskers as a result being finely dispersed in said mixture,
said homogenized mixture being extruded as said organic polymeric material at a later stage of said extruder.

The invention further discloses an organic polymeric material in which the characterising features of the polymer comprise a carbon based matrix, said carbon based matrix mainly comprising cellulose acetyl butyrate and a reinforcing dispersion of cellulose nano whiskers, said cellulose nano whiskers being finely dispersed within said carbon based matrix.

The invention lastly describes a method for producing cellulose nano whiskers comprising the following steps:
adding a microcrystalline cellulose compound to an aqueous solution to form a suspension in which the new and characterising steps comprise
subjecting said suspension to an acid hydrolysis process said acid being Hydrogen Chloride (HCl),
isolating said cellulose nano whiskers, and
suspending the thus produced cellulose nano whiskers in a liquid solution.

Further new and advantageous features are given in the attached dependent claims.

### FIGURE CAPTIONS

The figures are intended for illustration purposes solely and shall not be in any way be construed to limit the invention which shall only be limited by the attached claims.

FIG. 1 is an illustration of the extrusion process according to the invention in which is shown a first extrusion stage (51) into which is inserted the carbon based matrix material, a second extrusion stage (52) into which is inserted a dispersion (3, 4) comprising carbon nano whiskers (3) and a plasticizer (4), the extruder (5) comprising several ventilation stages (54), and an extruder outlet (53) through which the produced polymer (1) is extruded.

FIG. 2 is an illustration of the three different situations which may occur when reinforcing a carbon based matrix material (2) by means of nanoreinforcements (3).

FIG. 2a illustrates the nanoreinforcements (3) being in an agglomerated state. There is little or no dispersion of the nanoreinforcements (3) in the carbon based matrix material (2), and the reinforcing effect of the nanoreinforcements (3) on the polymer (1) will be small.

FIG. 2b illustrates the nanoreinforcements (3) being in a swollen state. There is an increased degree of dispersion of the nanoreinforcements (3) in the carbon based matrix material (2), and the reinforcement of the polymer (1) by the nanoreinforcements (3) will be improved compared to the situation illustrated in FIG. 2a.

FIG. 2c illustrates the nanoreinforcements (3) being in a fully dispersed state. There is a very large degree of dispersion of the nanoreinforcements (3) in the carbon based matrix material (2), and the reinforcement of the polymer (1) by the nanoreinforcements (3) will be considerably improved compared to the situation illustrated in FIGS. 2a and 2b. There is a risk that the nanoreinforcements (3) will flocculate during the mixing process of the nanoreinforcements (3) with the carbon based matrix material (2) resulting in a lower degree of reinforcement.

FIG. 3 is a representation of the temperature dependence of the stress (E′) and the tan δ representation for a pure Cellulose Acetate Butyrate polymer and a reinforced Cellulose Acetate Butyrate polymer.

FIG. 4 is a stress-versus-strain diagram given for a pure Cellulose Acetate Butyrate polymer and a reinforced Cellulose Acetate Butyrate polymer.

FIG. 5 is a graphical representation of the physical characteristics of cellulose nano whiskers produced by acid hydrolysis using HCl compared to cellulose nano whiskers produced by acid hydrolysis using H₂SO₄.

FIG. 6 is a photographical representation of the transparent qualities of the polymer (1) according to the invention. A sheet of the polymer (1) is seen covering a text on a light background.

### DESCRIPTION OF PREFERRED EMBODIMENTS OF THE INVENTION

The invention will in the following be described with reference to the attached figures. The invention discloses a method for manufacturing a reinforced organic polymeric material (1) comprising the following steps:
providing a carbon based matrix material (2),
providing a dispersion (3, 4) comprising at least a plurality of cellulose nano whiskers (3) and a liquid plasticizing material (4), said plasticizing material (4) for plasticizing said carbon based matrix material (2). The novel and inventive steps according to the invention comprise
furnishing said carbon based matrix material (2) and said dispersion (3, 4) to an extruder (5) so as for forming a mixture (2, 3, 4) of said dispersion (3, 4) with said carbon based matrix material (2),
homogenizing said mixture (2, 3, 4) by passing said mixture (2, 3, 4) through at least a portion of said extruder (5), said cellulose nano whiskers (3) as a result being finely dispersed in said mixture (2, 3, 4),
said homogenized mixture (2, 3, 4) being extruded as said organic polymeric material (1) at a later stage (53) of said extruder (5).

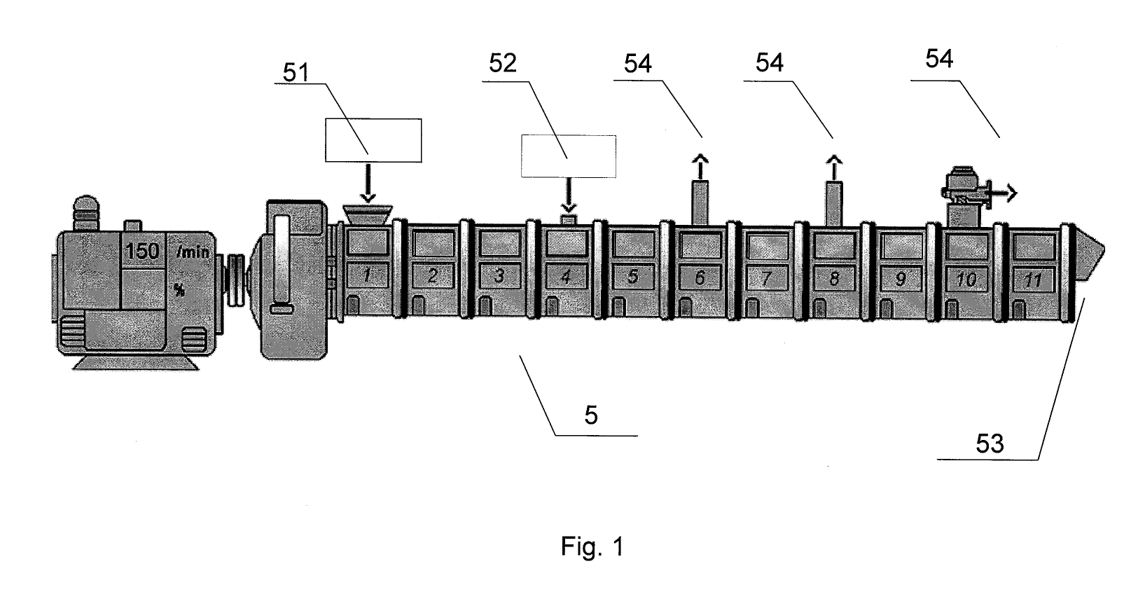

In a preferred embodiment of the invention said carbon based matrix material (2) is furnished at a first stage (51) of said extruder (5), and said dispersion (3, 4) is furnished into a second later stage of (52) of said extruder (5). This will allow the carbon based material (2) to be at least partially melted before pumping the dispersion (3, 4) into the material (2) allowing for an improved dispersion of the reinforcements (3) into the matrix (2). An illustration of the extruder (5) according to the present invention is shown in FIG. 1.

The matrix (2) is fed into the extruder aperture (51) and is a least partially melted when the dispersion (3, 4) of plasticizer is added to the matrix (2) by liquid pumping of the dispersion (3, 4) into the extruder aperture (52). The mixture (2, 3, 4) is mixed and homogenized along the length of the extruder screw before being extruded at an extruder die at the stage (53) of the extruder (5). One or more apertures (54) are arranged for venting the mixture (2, 3, 4) and will serve several purposes. The apertures (54) are used to prevent the formation of voids and thus reduce the porosity of the mixture (2, 3, 4), and also for homogenizing and strengthening the resulting polymer (1) by removing fluids such as excess plasticizer (4) or possible solvents (7).

There are several major advantages to using an extruder in the production of nanocomposites as described in the present invention. The extrusion process is known as a melt compounding process. The main advantage of mixing said dispersion (3, 4) into said matrix (2) by means of a melt compounding process is that one is able to very finely disperse the cellulose nanowhiskers (3) within the carbon based matrix (2). This problem of adequately dispersing the reinforcements (3) has proven to be one of the major obstacles in previous attempts to produce reinforced polymers. This problem is solved by pumping the liquid dispersion (3, 4) directly into the at least partially melted carbon based matrix (2) allowing for an improved mixing of the whiskers (3) into the matrix (2). The dispersion (3, 4) being liquid resolves two different process problems:
The nanowhiskers (3) show a tendency to agglomerate if not kept in a liquid suspension thus as a result being less dispersed in the matrix (2) and providing less reinforcement of the resulting organic polymeric material (1).
As the whiskers (3) are of relatively small size and mass, they are difficult to handle in a dry state as they will have a tendency to being perturbed by even very small impacts from air perturbations or other disturbances. They are further difficult to add to the matrix (2) due to the handling difficulties.

Using the method according to the present invention in which the liquid dispersion (3, 4) is pumped directly into the at least partially melted matrix (2) will thus resolve these problems. The extrusion process will firstly at least partially melt the carbon based matrix (2) into a liquid plastic. The addition of the liquid dispersion (3, 4) into the extruder will result in the liquid dispersion (3, 4) being thoroughly homogenized with the at least partially melted carbon based matrix (2) due to the extrusion screw or screws kneading and working on the mixture (2, 3, 4). Specially designed extrusion screws may in some instances be necessary for the improved homogenizing of the mixture. Such screws are known to the person skilled in the art.

Use of a liquid plasticizer will ease the extrusion of the mixture (2, 3, 4) and will for many mixtures (2, 3, 4) be required in order for the extrusion to be possible. The plasticizer (4) must evidently be able to plasticize the matrix (2), and must further not degrade the whiskers (3) nor itself be degraded during the extrusion process. The plasticizer should additionally not adversely affect the resulting properties of the polymer (1) to a too large degree. Any plasticizer (4) fulfilling the above conditions may be used in the process as will be evident to a person skilled in the art.

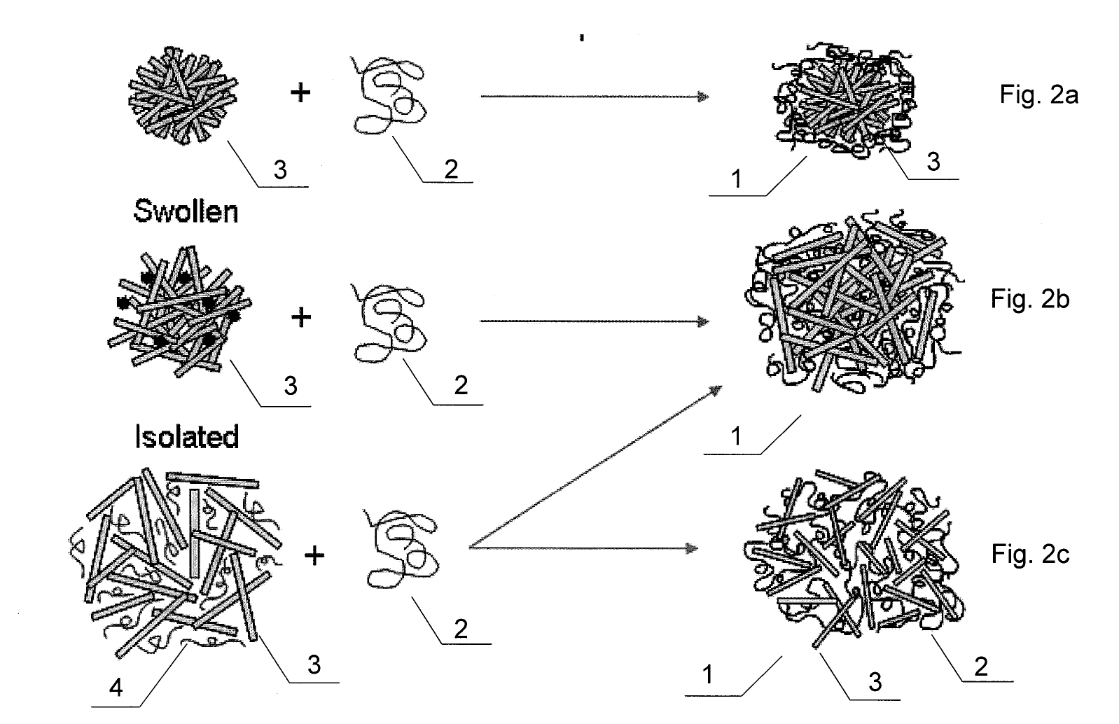

As shown in FIG. 2 the degree of dispersion of the nanoreinforcements (3) is a determining factor in the degree of reinforcement of the polymeric material (1). In an ideal situation the whiskers (3) are completely and homogenously dispersed in the polymer (1) and will eventually provide substantial reinforcement of the matrix (2). It is believed that using the above extrusion process one is able to approximate the situation as shown in FIG. 2c with respect to the dispersion of the nanowhiskers (3).

The extruder (5) may preferentially be specially adapted for nanocomposite processing, although most extruders (5) will probably adequately mix the dispersion (3, 4) into the matrix (2). Possible modifications of the extruder (5) for improving the mixing efficiency might include moving the kneading elements towards the extruder die at the extruder outlet (53) in order for building up pressure earlier in the extruder barrel. This may increase the degree of homogenization of the mixture (2, 3, 4).

The extrusion of the mixture (2, 3, 4) as a homogenized polymer (1) at the outlet (53) of the extruder (5) may be performed through any well-adapted extrusion die as will be evident to a person skilled in the art. The shape of the extrusion die will depend on which post treatment of the polymer (1) is desired and the use for which the polymer (1) is intended. The extruded polymer (1) may for instance be compression moulded into films or injection moulded into the desired products.

In a particularly preferred embodiment of the invention the carbon based matrix material (2) will comprise cellulose acetate butyrate (CAB) (21). Experimentation has shown that the use of CAB (21) as the matrix (2) will greatly improve the dispersion of the cellulose nano whiskers (3) in the matrix (2). This is presumed to be due to the chemical properties of the whiskers (3) and the matrix (2) being quite similar, although the precise mechanisms for the improved dispersion are not yet been fully understood. Compared to background art in which many means have been used to achieve the required amount of dispersion of the nanoreinforcements in the matrix (2) without success, this solution uses the natural affinities of two compounds being chemically similar to promote the dispersion.

The use of CAB (21) as the matrix material (2) is advantageous from an environmental point of view as CAB (21) is manufactured by the chemical modification of cellulose, and is thus an entirely renewable resource. CAB (21) is relatively chemically stable and is usually furnished as a powder or granular and may thus easily serve in the industrial production of polymers. CAB (21) also presents the major advantages of being biodegradable and being cheap compared to other matrix materials (2) having comparable physical properties.

The use of CAB (21) in the extrusion process necessitates an appropriate plasticizer as CAB (21) is relatively brittle and little adapted to extrusion. In a preferred embodiment of the invention, triethylcitrate C₁₂H₂₀O₇ (41) or TEC, is utilised as a well adapted plasticizer for CAB, albeit any plasticizer (4) being able to adequately plasticize CAB (21) may serve as is evident to person skilled in the art. TEC (41) however has the further advantage of being environmentally friendly.

When preparing the dispersion (3, 4) to be added to the matrix (2) the cellulose nanowhiskers (3) will thus in a preferred embodiment of the invention be suspended in TEC (41) wherein the TEC (41) will both serve as a plasticizer (4) for the extrusion process as well as serving as the liquid phase of the dispersion (3, 4).

In a further preferred embodiment of the invention, a solvent (7) may be added to the dispersion (3, 4) in order for rendering the dispersion more viscous and for reducing the required amount of plasticizer (4). As is evident, the solvent (7) must be soluble with respect to the plasticizer (4) and should not react with the matrix material (2) nor with the whiskers (3). The choice of solvent (7) will entirely depend on the choice of matrix material (2), whiskers (3) and the plasticizer (4).

In a preferred embodiment of the invention, a polar solvent (7) such as ethanol or methanol is chosen as the solvent (7). Ethanol is a cheap environmentally friendly solvent being inert with respect to most matrix materials (2). In the preferred embodiment of the invention in which TEC (41) serves as a plasticizer (4), TEC (41) will also serve to avoid the too fast evaporation of ethanol during the extrusion process. TEC (41) is not soluble in water, and the use of TEC (41)/ethanol as the liquid phase of the dispersion (3, 4, 7) is thus advantageous with respect to chemical affinities. In other embodiments of the invention, water and a compatible plasticizer may serve the same purpose.

In an alternative preferred embodiment of the invention, the proportion of TEC (41) in the dispersion (3, 4) also comprising the solvent (7) is about 30%. This use of a quite large proportion of plasticizer (4) allows increased process speeds thus allowing the process to be used industrially and not merely on a laboratory scale.

Although ethanol has served as example, it should be evident that other solvents (7) fulfilling the process requirements may serve equally well, and lie within the scope of protection of the present invention.

The addition of a solvent (7) may necessitate the removal of excess fluid before the polymer (1) is extruded. The arrangement of one or more vents (54) will in a preferred embodiment of the invention allow the easy removal of the excess liquids from the melt as described above.

The temperature gradient within the extruder (5) should be adapted to the materials used during the process. In the particular embodiment of the invention in which CAB serves as the matrix material, the extrusion temperature will preferentially vary between about 130° C. and about 210° C. Using other matrix materials (2) other temperature ranges will be used as is evident to a person skilled in the art.

The invention further discloses an organic polymeric material (1) comprising a carbon based matrix (2) mainly comprising cellulose acetyl butyrate (21) and a reinforcing dispersion of cellulose nano whiskers (3), said cellulose nano whiskers (3) being finely dispersed within said carbon based matrix (2). The particular advantages of the reinforced organic polymeric material (1) according to the invention are multiple, it being strong, transparent, and has a substantially improved temperature resistance compared to the non-reinforced CAB material (21).

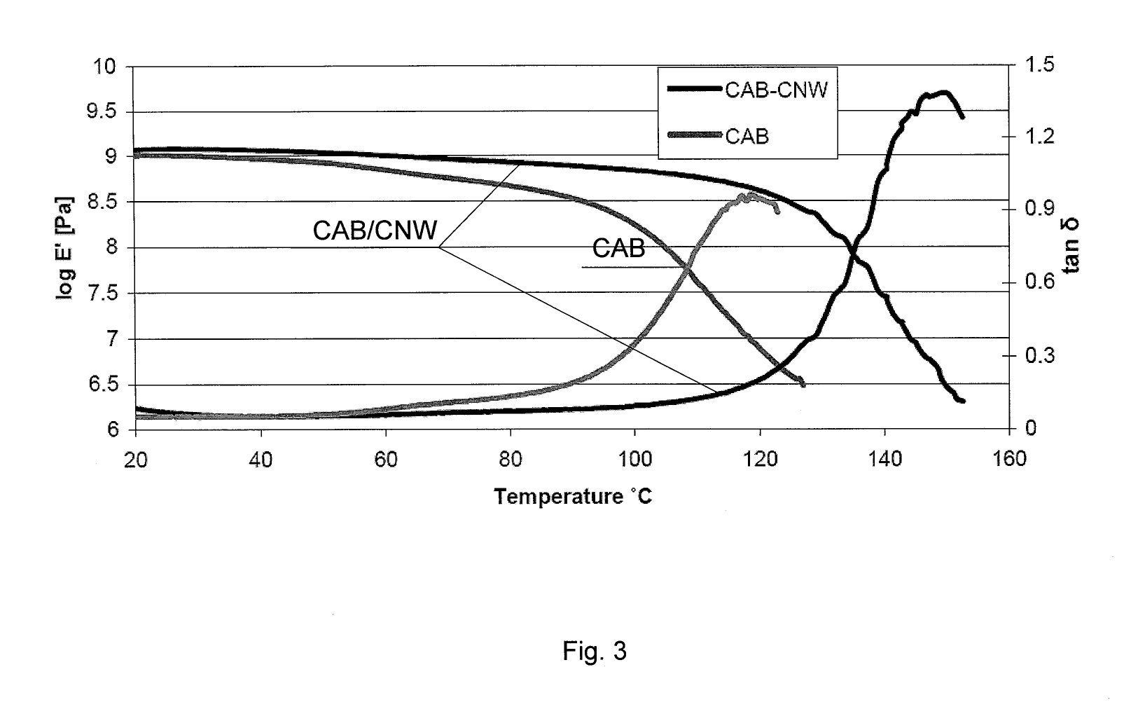

FIG. 3 illustrates the improvement of the whisker (3) reinforced CAB (21) polymer with respect to the unmodified material. As may be seen there is a large increase in both the tan δ peak and the storage modulus E′. The results are summarized in the below table:

| | | Storage modulus, |
|---|---|---|
| Material | tan δ peak temp | [MPa] (at 120° C.) |
| CAB | 117° C. | 7.46 |
| CAB-CNW | 148° C. | 4.05 × 10² |

The improvement in the softening temperature from 117° C. to about 148° C. is a very large improvement, and results from the addition of only about 5% nanowhiskers. As is evident to a person skilled in the art, the addition of larger amounts of reinforcing material may potentially further increase the tan δ peak temperature thus further increasing the strength of the material. With respect to the previously reported work in the field, this increase in the tan δ peak temperature as well as the increase in the storage modulus is remarkable. Neither Grunert and Winter^{[1]} nor Oksman et al^{[2]} were able to furnish similar or indeed significant improvements in the material properties.

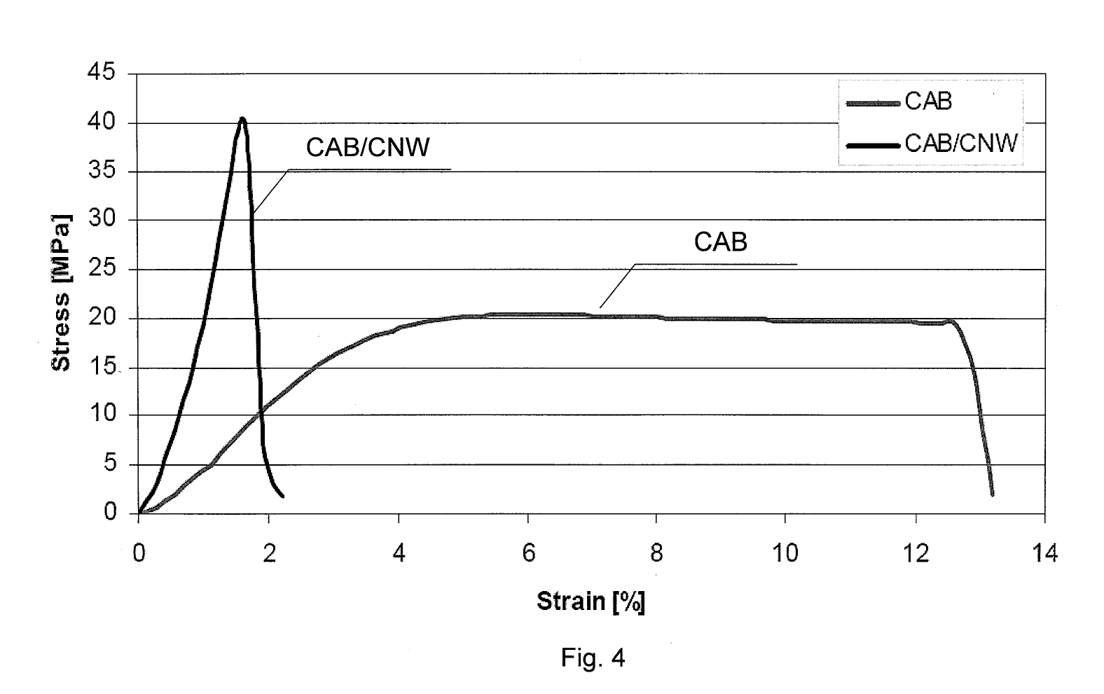

FIG. 4 is a graphical comparison of the tensile properties of pure CAB and whisker-reinforced CAB. As may be seen the tensile strength is increased by about 100% and the modulus by about 300%. Although the elongation at break is smaller for the modified material in the example, this is more than compensated for by the increase in strength. The comparison is furthermore given for a polymer (1) containing about 5% whiskers (3) and it is believed that the addition of a larger amount of reinforcement may further improve the mechanical properties of the polymer. A summary of the exemplary experimental results are given below:

| Material | σ_{TS} | E-modulus [GPa] | εbreak [%] |
|---|---|---|---|
| CAB | 20.1 | 0.8 | 13.4 |
| CAB-CNW | 40 | 3.2 | 1.7 |

An E-modulus of about 3.2 GPa has never been reported for biodegradable polymers of this kind. The result is in the orders of magnitude above what has been previously achieved.

It should be clear that other proportions of nano-reinforcements are possible, and that these also lie within the scope of the invention. Although experimental values for the addition of just 5% of nanoreinforcements are given, these are given as examples only, and should not be considered to limit the invention. The polymer may be tailor-made to specifications, in which the percentage of nanowhiskers may range from less than 0.1% to more than 30% according to the desired polymer characteristics.

A second possible explanation for the improved characteristics of the produced polymer (1) may lie in the improved method for the production of whiskers (3) according to the invention. Previous experimentation in the field has concentrated on the acid hydrolysis of the cellulose base material by means of sulphuric acid. However the resulting whiskers (3) have not proven to be adequate for the reinforcement of CAB (21). Thus a new and inventive method is proposed according to the invention in which cellulose nanowhiskers (3) are produced by the acid hydrolysis of microcrystalline cellulose by means of hydrochloric acid HCl. An example of the production methodology for the whiskers is given below.

Microcrystalline cellulose (MCC), is used to prepare the cellulose whiskers. In an example according to the invention 26 g of MCC is added to 900 ml 4 N HCl and heated at 80° C. for 225 min. The suspension is centrifuged repeatedly at 12000 rpm for 10 min. After each centrifugation step the supernatant is removed and replaced by distilled water, arranged on a magnetic stirrer and stirred until the sediment is blended. When the pH reaches ≧4, usually after approximately six centrifugations, the centrifugation speed is decreased to 3800 rpm for 10 min to obtain a turbid supernatant. The turbid supernatant is collected and replaced by distilled water. This step is repeated three times.

In order for ensuring that the suspension contains whiskers, it may be placed between a filter and stirred. If the suspension shows birefringence, which is the decomposition of a ray of light into two rays when it passes through crystals, this is an indication of that the microcrystalline cellulose has successfully been separated into single crystals or whiskers. The turbid suspension is put in dialysis tubes and placed in distilled water for approximately one week to remove excess acid. In order to concentrate the whisker suspension, the dialysis tubes may be placed in a polyethylene-glycol (PEG) bath for approximately one week.

This method according to the invention will result in cellulose nano whiskers (4) in the size range approximately 100 nm length to approximately 1000 nm length and having a diameter in the range of approximately 5 nm to approximately 15 nm. These are so-called one dimensional nanoparticles.

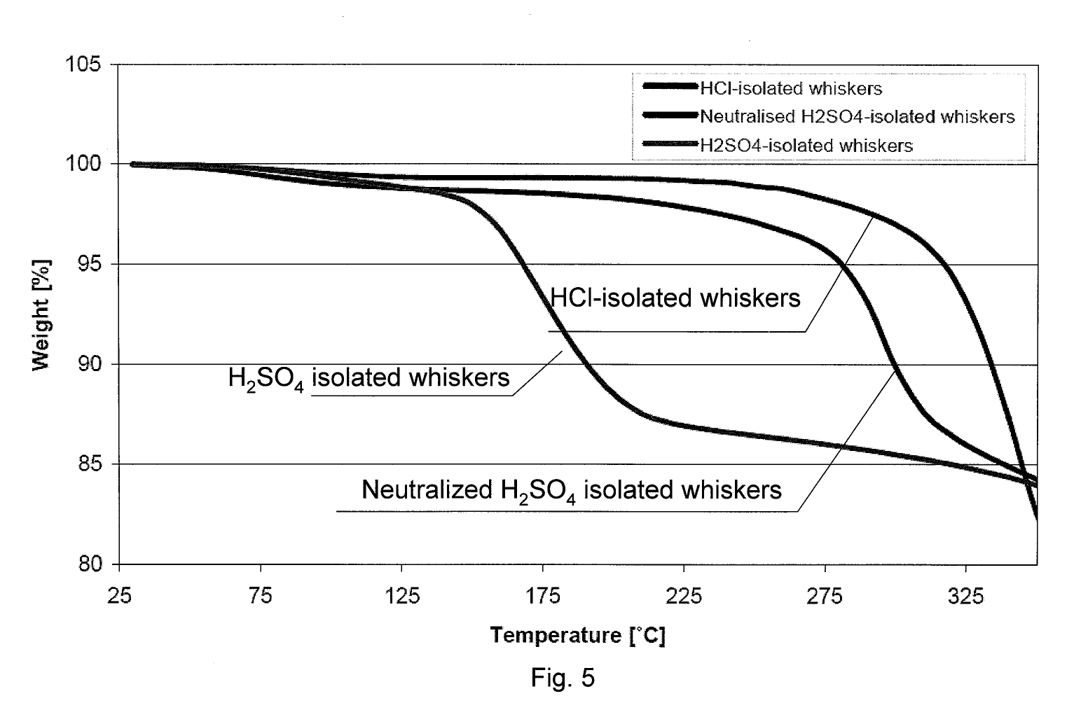

A comparison of the physical properties of the whiskers prepared by using HCl and the properties of the whiskers prepared by using H₂SO₄ is given in FIG. 5. As may be seen the HCl isolated whiskers present a substantially improved temperature profile with respect to resistance to thermal degradation compared to the whiskers produced by H₂SO₄ acid hydrolysis. This result may be due to the fact that sulphur is a thermally sensitive element, and that the presence of residual sulphur might contribute to the thermal degradation of the polymer. An alternative explanation is that H₂SO₄ may degrade the whiskers as was shown by Peterson and Oksman^{[3]} with respect to LiCl.

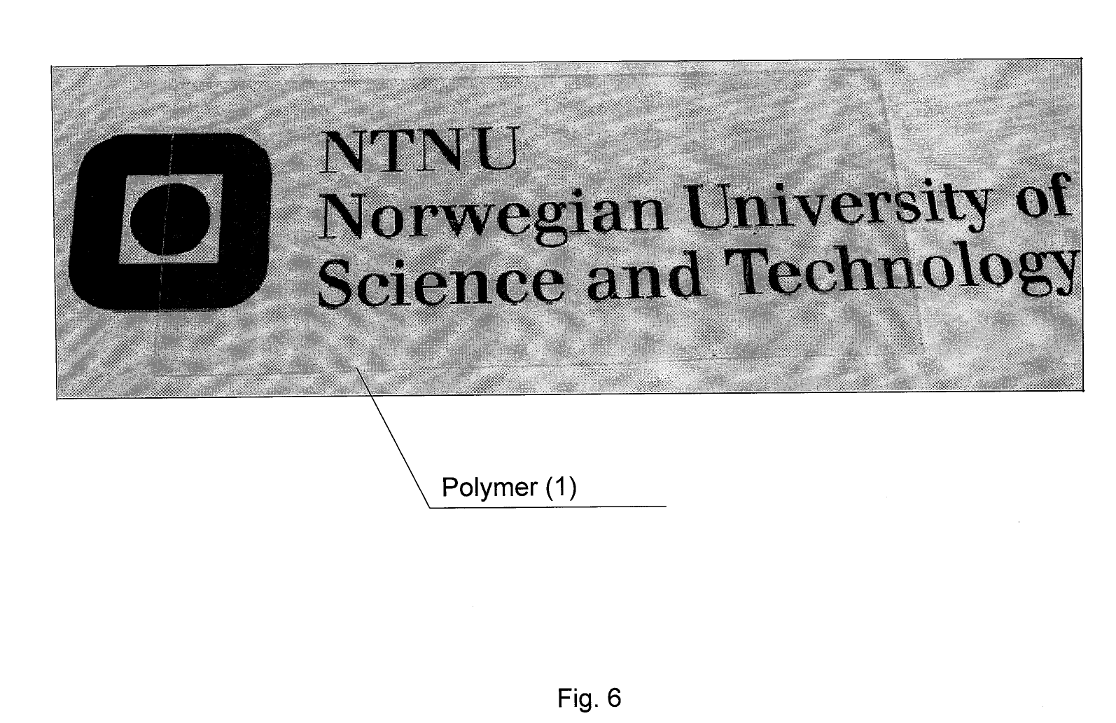

The resulting polymer (1) is very clear and transparent as may be seen in FIG. 6. This is of major importance in the industrial application of the polymer as a clear polymer may be desirable in applications such as food packaging or other applications in which a wrapped product should be clearly visible.

The resulting polymer (1) has many potential areas of use including packaging film, food packaging, electronics, biomedical applications etc. As the resulting polymer is cheap, biodegradable as well as strong, it presents multiple advantages compared to previously disclosed polymeric materials.

### REFERENCES

[1] Grunert, M., Winter, W. T.: “Nanocomposites of Cellulose Acetate Butyrate Reinforced with Cellulose Nanocrystals” Journal of polymers and the Environment, Vol. 10, no 1-2. 2002, p. 27-31
[2] Oksman, K. et al: “Manufacturing process of cellulose whiskers/polylactic acid nanocomposites”, Composites science and technology Volume 66, Issue 15, 1 Dec. 2006, Pages 2776-2784.
[3] Petersson, L., Oksman, K.: “Biopolymer based nanocomposites: Comparing layered silicates and microcrystalline cellulose as nanoreinforcement” Composites Science and Technology Volume 66, Issue 13, October 2006, Pages 2187-2196
[4] Pejis, T. and Vilaseca, F.: Cellulose-based nanocomposites: A review” 8th International Conference on Woodfiber-Plastic Composites (and other natural fibers) held May 23-25, 2005.
[5] Gacitua, W., Ballerini, A., Zhang, J.: Polymer nanocomposites: Synthetic and natural filler A review. Madera. Ciencia y tecnologica 7 (3): 159-178 2005.
[6] Nair, K. G., Dufresne, A.: “Crab shell chitin whiskers reinforced natural rubber nanocomposites 1. Processing and swelling behaviour” Biomacromolecules 2003, 4, 657-665
[7] Nair, K. G., Dufresne, A.: “Crab shell chitin whiskers reinforced natural rubber nanocomposites. 2. Mechanical behaviour” Biomacromolecules 2003, 4, 666-674
[8] Nair, K. G., Dufresne, A.: “Crab shell chitin whiskers reinforced natural rubber nanocomposites. 3. Effect of chemical modification of chitin whiskers.” Biomacromolecules 2003, 4, 1835-1842
[9] Kim, Y. K. et al: “Nanocomposite fibers” National textile center annual report, November 2002.
[10] Bondeson, D., Mathew, A., Oksman, K.: “Optimization of the isolation of nanocrystals from microcrystalline cellulose by acid hydrolyses” Cellulose (2006) Volume 13 Number 2/April, 2006:171-180
[11] Morin, A., Dufresne, A.: “Nanocomposites of chitin whiskers from Riftia tubes and pol(caprolactone)”Macromolecules 2002, 35, 2190-2199

What is claimed is:

1. A method for producing a reinforced organic polymeric material (1) comprising the following steps:
providing a carbon based matrix material (2),
providing a dispersion (3, 4) comprising at least a plurality of cellulose nano whiskers (3) and a liquid plasticizing material (4), said plasticizing material (4) for plasticizing said carbon based matrix material (2) characterised in
furnishing said carbon based matrix material (2) and said dispersion (3, 4) to an extruder (5) so as for forming a mixture (2, 3, 4) of said dispersion (3, 4) with said carbon based matrix material (2),
homogenizing said mixture (2, 3, 4) by passing said mixture (2, 3, 4) through at least a portion of said extruder (5), said cellulose nano whiskers (3) as a result being finely dispersed in said mixture (2, 3, 4),
said homogenized mixture (2, 3, 4) being extruded as said reinforced organic polymeric material (1) at a later stage (53) of said extruder (5).

2. A method according to claim 1, in which said carbon based matrix material (2) is furnished at a first stage (51) of said extruder (5), and said dispersion (3, 4) is furnished into a second later stage of (52) of said extruder (5).

3. A method according to claim 1 in which said carbon based matrix material (2) mainly comprises cellulose acetate butyrate (21).

4. A method according to claim 1 in which said plasticizing material (4) mainly comprises triethylcitrate (41).

5. A method according to claim 1 in which said dispersion (3, 4) further comprises a solvent (7).

6. A method according to claim 5, in which the proportion of said plasticizing material (4) in said dispersion (3, 4) with said solvent (7) is about 30%.

7. A method according to claim 5 in which said a major portion of said solvent (7) and or said plasticizer (4) is removed by ventilation from said mixture (2, 3, 4) through one or more vents (54) prior to said mixture (2, 3, 4) being extruded as said organic polymeric material (1) at said third stage (53).

8. A method according to claim 5 in which said solvent (7) is a polar solvent.

9. A method according to claim 8 in which said solvent (7) mainly comprises ethanol.

10. A method according to claim 1 in which the extrusion process is performed at an operating temperature above 130° C.

11. A method according to claim 1 in which the extrusion process is performed at an operating temperature below 210° C.

12. A method according to claim 1 in which said cellulose nano whiskers (3) are produced according to a method comprising the following steps:
adding a microcrystalline cellulose (31) compound to an aqueous solution to form a suspension (32)
subjecting said suspension (32) to an acid hydrolysis process said acid being Hydrogen Chloride (HCl), and
isolating said cellulose nano whiskers (3) and suspending said cellulose nano whiskers in a liquid solution.

13. An organic polymeric material (1) characterised in comprising a carbon based matrix (2), said carbon based matrix (2) mainly comprising cellulose acetyl butyrate (21) and a reinforcing dispersion of cellulose nano whiskers (3),
said cellulose nano whiskers (3) being finely dispersed within said carbon based matrix (2).

14. A polymer (1) according to claim 13 in which said cellulose nano whiskers (4) are in the size range approximately 100 nm length to approximately 1000 nm length and having a diameter in the range of approximately 5 nm to approximately 15 nm.

15. A polymer (1) according to claim 13 in which said polymer (1) has glass temperature of about 150° C.

16. A polymer (1) according to claim 13, in which said polymer (1) has a tensile modulus of about 3.5 GPa.

17. A polymer according to claim 13 in which said polymer (1) is transparent.

18. A method for producing cellulose nano whiskers (3) comprising the following steps:
adding a microcrystalline cellulose (31) compound to an aqueous solution to form a suspension (32) characterised in
subjecting said suspension (32) to an acid hydrolysis process said acid being Hydrogen Chloride (HCl),
isolating said cellulose nano whiskers (3), and
suspending the thus produced cellulose nano whiskers (3) in a liquid solution.
